(19) United States
(12) Patent Application Publication
(10) Pub. No.: US 2024/0157473 A1
(43) Pub. Date: May 16, 2024

(54) Formation Of An Ultrathin Mixed Surface Layer By Ultrashort Pulsed Laser Irradiation Of Alternating Metallic Film Stacks

(71) Applicant: THE REGENTS OF THE UNIVERSITY OF MICHIGAN, Ann Arbor, MI (US)

(72) Inventors: Steven YALISOVE, Ann Arbor, MI (US); Ben Torralva, Ann Arbor, MI (US); Abdul Ansari, Ann Arbor, MI (US)

(21) Appl. No.: 18/508,504

(22) Filed: Nov. 14, 2023

Related U.S. Application Data
(60) Provisional application No. 63/424,981, filed on Nov. 14, 2022.

(51) Int. Cl. B23K 26/0622

(52) U.S. Cl. CPC B23K 26/0624; B23K 2103/50

(57) ABSTRACT

Methods, systems, and apparatus to mix thin films using ultrafast irradiation with low-fluence pulses while imparting a minimal thermal load and affording tighter confinement of the modification than existing methods. In some embodiments, this is achieved by depositing thin films of the species to be mixed in alternating layers and then irradiating repeatedly by multiple pulses at or below the melt threshold for the species.

### CROSS-REFERENCE TO RELATED APPLICATIONS

This application claims the benefit of U.S. Provisional Application No. 63/424,981 filed on Nov. 14, 2022. The entire disclosure of the above application is incorporated herein by reference.

### FIELD

The present disclosure relates to mixing of materials and, more particularly, relates to forming an ultrathin mixed surface layer by ultrashort pulsed laser irradiation of alternating film stacks.

### BACKGROUND AND SUMMARY

This section provides background information related to the present disclosure which is not necessarily prior art. This section provides a general summary of the disclosure, and is not a comprehensive disclosure of its full scope or all of its features.

Lasers are widely used to modify materials for use in manufacturing applications. Ultraviolet wavelengths are used in lithography in cutting-edge nodes to manufacture semiconductor devices, as a heat source for surface melting, ablation, or joining, and in precision micromachining. A major challenge in the generation of devices is the annealing of 3D architectures. Here, low thermal budget processing is integral to minimizing the damage imparted to existing structures. Pulsed lasers with picosecond and longer pulse duration have found such use in processing of photovoltaics while ultrafast lasers have begun recently emerging as a tool for semiconductors processing.

Ultrafast lasers have pulse durations less than a few picoseconds (ps), a duration shorter than electron-phonon relaxation times, which are usually between 1-10 ps. This results in the decoupling of electron excitation and lattice heating. The lattice response to electron-phonon thermalization changes as the amount of deposited energy increases. At low pulse intensity, if a sufficient number of bonded valence electrons are excited, the surface of a semiconductor can experience nonthermal melting. This occurs due to the loss of electrons that originally bonded lattice ions in place, allowing the ions to drift and introduce disorder in the lattice. At irradiation intensities above the melt threshold, thermal melting follows. At low irradiation intensities, the disordering effect can be low enough to only generate defects. This has been shown in gallium arsenide (GaAs) where repeated irradiation by 150 femtoseconds (fs) pulses below the melt threshold of GaAs forms surface corrugations known as laser induced periodic surface structures (LIPSS). These structures begin as point defects formed when some lattice ions, drifting with their room-temperature velocity after electronic excitation by an ultrafast laser pulse, are not on a lattice site when the electrons relax and restore atomic bonds. These interstitials leave behind a vacancy, creating a dissociated Frenkel Pair, and are in a highly stressed state due to the ions on the lattice around them. Subsequent pulses generate more pairs and result in their diffusion to the surface. The laser-enhanced diffusion coefficient was calculated from measurements to be as much as twenty orders of magnitude higher than the coefficient at homologous temperature 0.9 T_{M}. This kind of mass transport via diffusional mechanisms is normally only seen in the liquid state. While previous studies have demonstrated diffusion of a dopant into silicon by melting with ultrafast laser pulses, the study in GaAs suggests the possibility of solid-state mixing. This disclosure demonstrates such mixing on the surface of a stack of alternating nickel-tungsten films irradiated by numerous ultrafast laser pulses.

It has been found in accordance with the present teachings that by depositing and then irradiating alternating layers, it is possible to mix species on the surface using a femtosecond laser. In some embodiments, this low-fluence, repeated-exposure method allows the mixing to be restricted to a depth less than 25 nanometers (nm) below the surface and a thicker buffer layer results in a further confinement of the mixed region to approximately 10 nm. The result is that it is possible to selectively create a mixed material on the surface—and control the thickness of this mixed layer—by a much higher degree of precision than by conventional means. This allows for mixing and patterning on surfaces without disrupting the geometry of existing surfaces or adding a large thermal load to the underlying substrate.

Furthermore, it is possible that a nonthermal mechanism may be driving the mixing, as the mixed layer forms from the accumulation of pit-like defects on the surface of the material—a behavior that is remarkably similar to the formation of LIPSS in GaAs which occurs in the solid state. Such a mechanism would enable the ability to selectively dope the surfaces of semiconductors by enhancing diffusion between metal and semiconducting species, finely control thicknesses of mixed layers as needed for battery contacts, and potentially even access liquid-like diffusion in metals while in the solid state.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1A illustrates a schematic of an experimental platform. Inset FIG. 1B shows a STEM image of the layers as they were deposited. Inset FIG. 1C shows the EDS map, showing contrast between the individual layers, where Ni is in red and W is in green (or resultant grey scale according to the legend in upper left corner).

FIGS. 2A and 2B illustrate a cross section STEM and EDS image, respectively, after irradiating with 1000 pulses at a fluence of 0.11 J cm⁻².

FIG. 3A illustrates a cross section STEM after irradiating with 1000 pulses at a fluence of 0.097 J cm⁻².

FIG. 3B illustrates an EDS chemical map of the region.

FIG. 4A illustrates an unirradiated film stack where the middle Ni layer is twice as thick to behave as a buffer to diffusion with a high angle annular dark-field (HAADF) scanning transmission electron microscopy (STEM) image.

FIG. 4B illustrates an unirradiated film stack where the middle Ni layer is twice as thick to behave as a buffer to diffusion with an energy dispersive spectroscopy (EDS) map.

FIG. 5A illustrates an unirradiated film stack deposited on sapphire, which tamps the stack with a HAADF STEM image. The sapphire substrate is at the bottom of the image and the Ni heat sink is at the top.

FIG. 5B illustrates the EDS map of the unirradiated film stack tamped by sapphire.

FIG. 6A illustrates the result of irradiating the tamped film stack with 1000 pulses with a fluence of 0.07 J cm⁻² as a HAADF image. All but the upmost 3-4 films are mixed. There are no grooves or HSFL.

FIG. 6B illustrates the EDS map of a tamped film stack irradiated by 1000 pulses with a fluence of 0.07 J cm⁻². All but the upmost 3-4 films are mixed.

FIG. 7 illustrates an optical design used for performing the mixing experiments.

Corresponding reference numerals indicate corresponding parts throughout the several views of the drawings.

### DETAILED DESCRIPTION

Example embodiments will now be described more fully with reference to the accompanying drawings. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

In accordance with the principles of the present teachings, it has been found methods, systems, and apparatus to mix thin films using ultrafast irradiation with low-fluence pulses while imparting a minimal thermal load and affording tighter confinement of the modification than existing methods. In some embodiments, this is achieved by depositing thin films of the species to be mixed in alternating layers and then irradiating repeatedly by multiple pulses at or below the melt threshold for the species which melts more easily.

It is understood that the mechanism that drives this is a similar mechanism that leads to the formation of high spatial frequency laser induced periodic surface structures (LIPSS) on gallium arsenide (GaAs) surfaces. These point to the ability to modify a wide range of species and extend the mechanism for laser-enhanced defect generation and diffusion to a broader range of materials, such as, but not limited to, metals, metallic films, and the like.

It has been found that the diffusion rates for GaAs self-interstitials during ultrafast laser irradiation is about 20 orders of magnitude higher relative to diffusion at homologous temperatures of 0.4 T_{M}. The diffusion rate is comparable to diffusion in the liquid state despite being in the solid state. The present teachings leverage such enhanced diffusion to mix materials at irradiation fluences that avoid appreciable heating and thermal load below the skin depth of the material (˜15 nm for Ni and ˜24 nm for W). This is made possible by the unique interaction between a femtosecond laser pulse and electrons in the absorbing region of the surface. Upon irradiation, electrons are excited by the femtosecond pulse and take approximately 1-10 nanoseconds (ns) to fully relax. Lattice ions are able to freely drift during the first 1 to 10 ps, forming interstitials and vacancies. Enhanced diffusion will continue to occur for the next few nanoseconds. They are then able to diffuse during excitations from subsequent pulses. Thus, any diffusion that occurs is within 10 ns after excitation. Repeated excitation by pulses that are sufficiently low fluence to not melt the surface is what allows the material to diffuse and mix. Furthermore, as defects diffuse to the surface, they accumulate to form LIPSS.

The present method is guided by post-mortem scanning electron micrography (SEM) showing the development of the LIPSS which mirror their formation in GaAs, scanning transmission electron micrography (STEM) and energy dispersive X-ray spectroscopy (EDS) which show the layers having mixed through atomic contrast and through chemical maps.

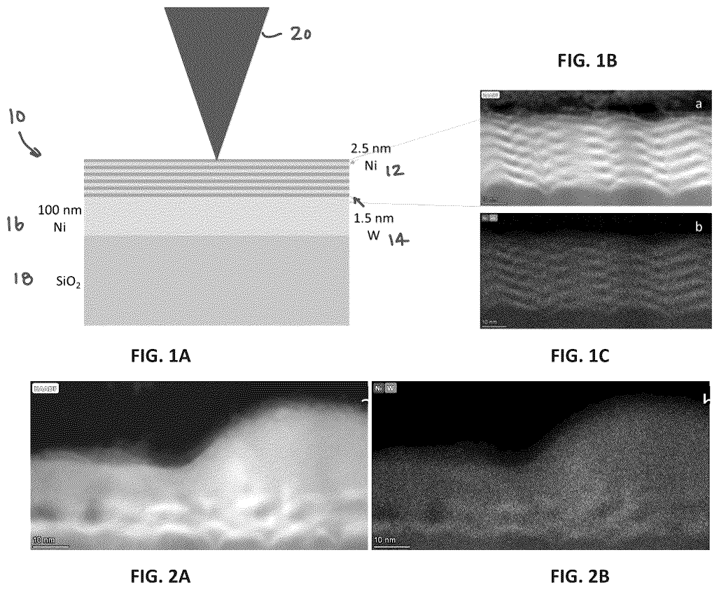

FIG. 1A illustrates a schematic of an experimental platform, wherein inset image FIG. 1B shows a STEM image of the layers as they were deposited and inset image FIG. 1C shows the EDS map, showing contrast between the individual layers wherein Ni is in red and W is in green (or corresponding grey scale gradient depicted in the legend in the upper left corner of FIG. 1C). That is, more particularly, the present demonstration used a stack 10 consisting of 12 alternating layers of 2.5 nm Ni films 12 and 1.5 nm W films 14, shown in FIG. 1A with accompanying STEM images verifying the structure. These were deposited on a 100 nm Ni heat sink 16 which was deposited on a glass substrate 18. The surface layer was of W and irradiation was performed by directing an ultrafast laser pulse 20 onto this stack 10. Irradiating by 1000, 150 fs pulses separated by a millisecond (ms) between irradiations results in the formation of high spatial frequency LIPSS (HSFL) on the surface which were imaged by SEM. In the tamped geometry, the film stack is first deposited onto a transparent sapphire substrate and then the heat sink onto the film stack. “Tamped,” as used herein, refers to the suppression of surface diffusion by a combination of the absence of a free surface and the possibility of a higher-pressure region because of the impedance mismatch of the two materials. It should further be understood that tamping layers generally describes a layer where the laser is absorbed, and a strong acoustic shock wave that propagates into the material beneath it. Irradiation is then performed by focusing the laser onto the film stack through the sapphire.

When viewing the sample under cross section STEM, one can see that the layers have mixed as seen in FIGS. 2A and 2B. That is, FIGS. 2A and 2B illustrate cross section STEM and EDS images, respectively, after irradiating with 1000 pulses at a fluence of 0.11 J cm⁻². An HSFL corrugation has formed and consists of mixed species and the surface between corrugations also consists of mixed material. Ni is in red and W is in green (or resultant grey scale according to the legend), showing that the lowest W layer is still intact. This suggests that the mixing is confined to a thickness of 20±2 nm below the surface.

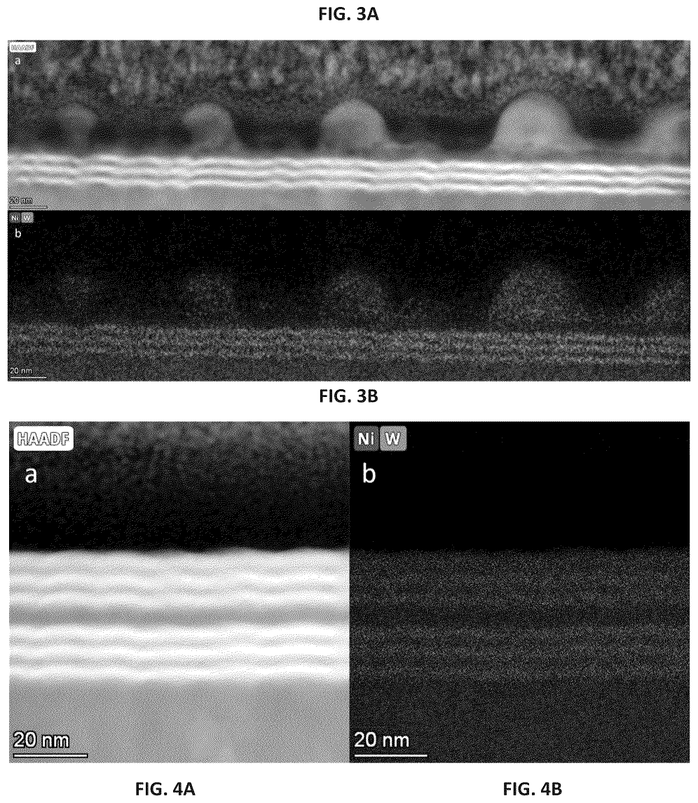

Furthermore, in some embodiments as illustrated in FIGS. 3A and 3B, a Ni layer was deposited in the center of the alternating film stack and showed that modification can be further confined to the surface as atoms from the surrounding W layers are unable to diffuse through the thicker Ni layer. More particularly, FIG. 3A illustrates a cross section STEM after irradiating with 1000 pulses at a fluence of 0.097 J cm⁻². The 4th Ni layer was deposited with a thickness of 5 nm instead of 2.5 nm. HSFL corrugations have formed. b, EDS chemical map of the region. Ni is in red and W is in green (or resultant grey scale according to the legend), showing that the HSFL consists of a mix of the two species and that the layers under the Ni film are unperturbed. This shows that the thicker Ni layer confined the surface modification to the layers above, a depth of about 13.5±2 nm below the original surface.

In some embodiments, as illustrated in FIGS. 4A and 4B, an unirradiated film stack, where the middle Ni layer is twice as thick, can behave as a buffer to diffusion. FIG. 4A illustrates a HAADF STEM image and FIG. 4B illustrates an EDS map, where Ni is in blue and W is in orange (or resultant grey scale according to the legend).

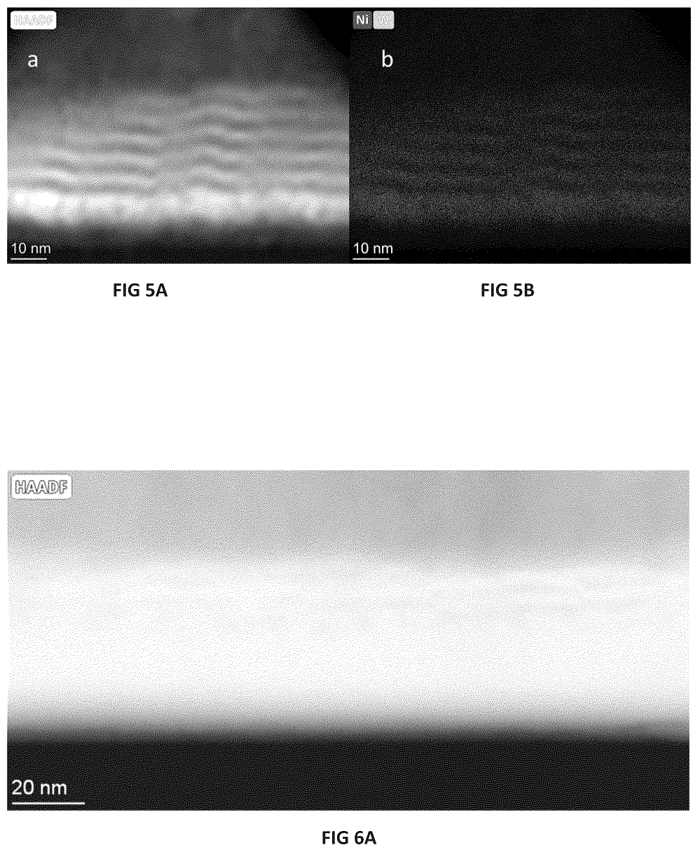

The film stack can be tamped by a transparent substrate such as sapphire, as illustrated in FIGS. 5A and 5B. The film stack is now sandwiched between the heat sink and the sapphire and irradiation can occur through the sapphire onto the stack. FIG. 5A illustrates a HAADF STEM image and FIG. 5B illustrates an EDS map. Ni is in blue (darker in HAADF) and W is in yellow (brighter in HAADF). The change of air to sapphire at the dielectric-metal interface changes the electronic properties of the film and can suppress HSFL formation. The tamped geometry also permits mixing deeper than the skin depth.

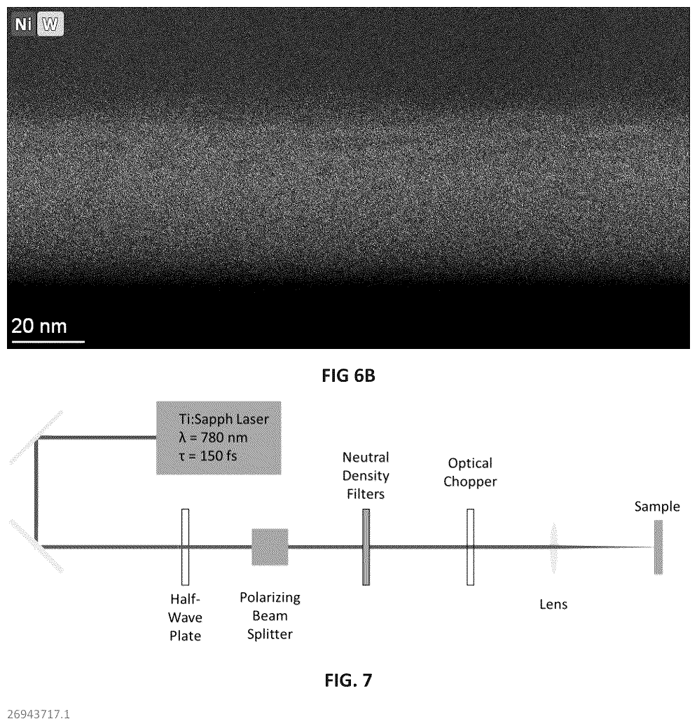

Irradiating the film stack through the sapphire with 1000 pulses at a fluence of 0.07 J cm⁻² results in mixing of the species. FIG. 6A illustrates mixing in the tamped layers with HAADF and shows no discernible contrast in the layers. The bottom dark region is the sapphire, the lighter grey is the mixed region, while the darker grey at the top is the Ni heat sink. FIG. 6B shows the EDS map of the irradiated region. The mixing depth reaches the final two W layers and thus is not confined to the skin depth but can extend it to 30±2 nm. This demonstrates the range of mixing depth control that this method provides. Most importantly, the mixing occurs without HSFL formation and does not change the morphology as with un-tamped geometries.

FIG. 7 illustrates an optical design used for performing the mixing experiments. The neutral density filters are used to coarsely adjust the laser fluence while the half-wave plate and polarizing beam splitter are used for more precise fluence tuning. The optical chopper is used to obtain a pulse repetition rate of 100 Hz on the sample.

The present invention is notable for several reasons. Firstly, the mixing is confined to a very thin region—approximately 20±2 nm below the surface—which is significantly thinner than mixing achieved by other laser techniques such as laser surface alloying or cladding. Secondly, the laser fluences used are very close to, but below, the melt threshold of Ni. This is significant because it either means that mixing occurred without melting or, if melting did occur, it melted the surface layer of Ni and the layers underneath likely mixed without melting. This is very valuable as it reduces the possibility of damaging heat-sensitive chemical or mechanical structures when using this technique in practical applications. Finally, the present invention is valuable for applications that require good interface conductivity such as in interconnects for battery assemblies. Decreasing interconnect thickness leads to an increase in interface conductivity, and the present invention can be used to mix to a depth limited by the skin depth of light in the materials. Use of a laser enables precision machining which can be used to pattern or etch traces for semiconductors by depositing masks and selectively doping without affecting previously patterned layers, as well. Furthermore, while ultrashort laser pulses to create corrugated surfaces has found application in creating low-friction surfaces, these surfaces experience degradation of this property over time as the structure mechanically deteriorates. By using femtosecond lasers to mix materials, control of the species and their relative concentrations can be used to create alloys which can be significantly more durable than pure elements and may also manifest in stable nanograins, creating durable low-friction surfaces which are resistant to mechanical wear and corrosion.

As demonstrated in connection with this mechanism in GaAs and in metals, it should be understood that the present teachings and principles are widely applicable to a variety of materials. The irradiating fluences, film thicknesses, number of pulses, and irradiation wavelengths can be tuned to vary the formation parameters and gain insight into the effect of interfaces on light absorption and band-gap modification. It is anticipated that a wide range of varying reagent materials are applicable in the present teachings.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method forming an ultrathin mixed surface layer by ultrafast irradiation of alternating film stacks comprising:
providing a stack of alternating layers of a first material and a second material, each layer being less than about 2.5 nm thick; and
irradiating a portion of the stack by directing an ultrafast laser pulse onto a top surface of the stack with a plurality of laser pulses to form high spatial frequency LIPSS (HSFL) within the stack at or below a melt temperature of the first material.

2. The method according to claim 1, wherein the first material is made of Ni and the second material is made of W.

3. The method according to claim 1, wherein the step of providing a stack of alternating layers of a first material and a second material comprises providing a stack of alternating layers of 2.5 nm Ni and 1.5 nm W films.

4. The method according to claim 1, wherein the step of providing a stack of alternating layers of a first material and a second material comprises depositing alternating layers of a first material and a second material upon a heat sink deposited on a substrate.

5. The method according to claim 1, wherein the step of irradiating a portion of the stack by directing an ultrafast laser pulse onto a top surface of the stack with a plurality of laser pulses to form high spatial frequency LIPSS (HSFL) within the stack at or below a melt temperature of the first material comprises irradiating a portion of the stack by directing an ultrafast laser pulse onto a top surface of the stack with a plurality of laser pulses to form high spatial frequency LIPSS (HSFL) within the stack to a depth less than 25 nm below the top surface.

6. The method according to claim 1, wherein the step of providing a stack of alternating layers of a first material and a second material comprises providing a stack of alternating layers of a first material and a second material having a buffer layer interposed within the alternating layers, the buffer layer being thicker than each of the alternating layers.

7. The method according to claim 6, wherein the step of irradiating a portion of the stack by directing an ultrafast laser pulse onto a top surface of the stack with a plurality of laser pulses to form high spatial frequency LIPSS (HSFL) within the stack at or below a melt temperature of the first material comprises irradiating a portion of the stack by directing an ultrafast laser pulse onto a top surface of the stack with a plurality of laser pulses to form high spatial frequency LIPSS (HSFL) within the stack to a depth less than 10 nm below the top surface.

8. The method according to claim 1, wherein the first material has a melt temperature less than the second material.

9. A method forming an ultrathin mixed interfacial layer by ultrafast irradiation of alternating film stacks comprising:
providing a stack of alternating layers of a first material and a second material, each layer being less than about 2.5 nm thick and deposited on a transparent dielectric substrate; and
irradiating a portion of the stack by directing an ultrafast laser pulse through the transparent dielectric substrate onto the top surface of the stack with a plurality of laser pulses to form a mixed layer without forming high spatial frequency LIPSS (HSFL) within the stack at or below a melt temperature of at least one of the first material and the second material.

10. The method according to claim 9 wherein the irradiating a portion of the stack by directing an ultrafast laser pulse through the transparent dielectric substrate onto the top surface of the stack with a plurality of laser pulses to form a mixed layer without forming high spatial frequency LIPSS (HSFL) within the stack is performed at or below a melt temperature of both the first material and the second material.

11. The method according to claim 9 wherein the mixed layer extends through both the first material and the second material.

12. The method according to claim 9 wherein the mixed layer extends to 28 nm to 32 nm.
